(19) United States
(12) Patent Application Publication
(10) Pub. No.: US 2006/0044280 A1
(43) Pub. Date: Mar. 2, 2006

(54) Interface

(76) Inventors: Wyatt Allen Huddleston, Allen, TX (US); Richard A. Robideaux, Albany, OR (US); John R. McNew, San Diego, CA (US); Michael M. Blythe, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/930,987

(22) Filed: Aug. 31, 2004

(51) Int. Cl. G09G 5/00

(52) U.S. Cl. 345/173

(57) ABSTRACT

An attribute of an image of an object produced by placing the object on an exterior surface of a touch screen of an interface is determined, and a property of an input to the interface is determined based on the attribute of the image.

### BACKGROUND

Touch-screen interfaces, e.g., for computers, electronic games, or the like, typically include on\off contact, can receive a single input at a time, and cannot determine pressures and/or velocities that a user's finger or other compliant object is applying to the surface. This limits the utility of these touch-screen interfaces, especially for use as virtual musical instruments.

### DESCRIPTION OF THE DRAWINGS

FIG. 1 illustrates an embodiment of a touch-screen interface, according to an embodiment of the present disclosure.

FIG. 2 illustrates the shape of an object positioned on an embodiment of a touch-screen interface when exerting different pressures on the interface at different times, according to another embodiment of the present disclosure.

FIG. 3 illustrates the shape of an object rolling over an embodiment of a touch-screen interface at different times, according to another embodiment of the present disclosure.

FIG. 4 illustrates an embodiment of a touch-screen interface in operation, according to another embodiment of the present disclosure.

FIG. 5 illustrates an embodiment of a network of touch-screen interfaces, according to another embodiment of the present disclosure.

### DETAILED DESCRIPTION

In the following detailed description of the present embodiments, reference is made to the accompanying drawings that form a part hereof, and in which is shown by way of illustration specific embodiments. These embodiments are described in sufficient detail to enable those skilled in the art to practice these embodiments, and it is to be understood that other embodiments may be utilized and that process, electrical or mechanical changes may be made without departing from the scope of the present disclosure. The following detailed description is, therefore, not to be taken in a limiting sense, and the scope of the present disclosure is defined only by the appended claims and equivalents thereof.

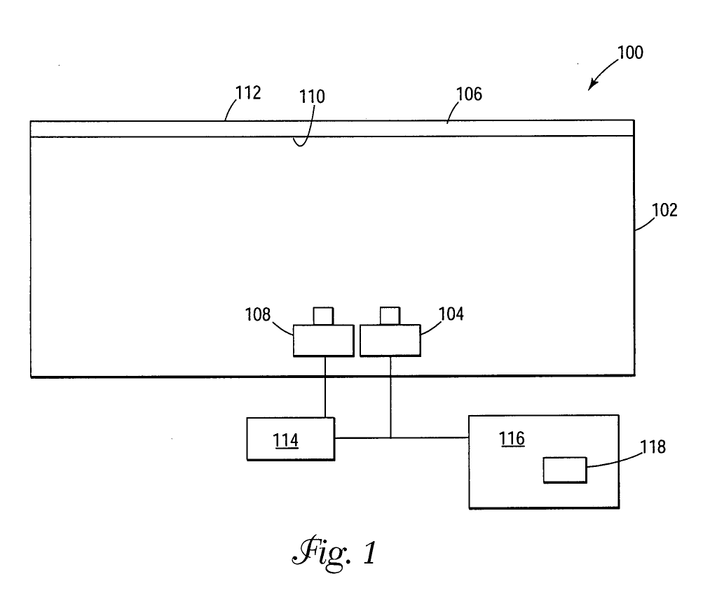

FIG. 1 illustrates a touch-screen interface 100, according to an embodiment of the present disclosure. For one embodiment, touch-screen interface 100 includes a rear-projection device 102, e.g., similar to a rear projection television, that includes a projector 104, such as a digital projector. Projector 104 projects images onto a projection screen 106 that transmits the images therethrough for viewing. A video camera 108, such as digital video camera, is directed at a rear side (or interior surface or projection side) 110 of projection screen 106 for detecting images resulting from reflections off of compliant objects, such as fingers, placed on a front side (or exterior surface or viewing side) 112 of projection screen 106. Camera 108 is connected to a video-capture device (or card) 114 that is connected to a processor 116, such as a personal computer. For one embodiment, the video-capture device 114 is integrated within touch-screen interface 100 or processor 116. For another embodiment, processor 116 is integrated within touch-screen interface 100. Processor 116 is also connected to projector 104.

For another embodiment, processor 116 is adapted to perform methods in accordance with embodiments of the present disclosure in response to computer-readable instructions. These computer-readable instructions are stored on a computer-usable media 118 of processor 116 and may be in the form of software, firmware, or hardware. In a hardware solution, the instructions are hard coded as part of an application-specific integrated circuit (ASIC) chip, for example. In a software or firmware solution, the instructions are stored for retrieval by processor 116. Some additional examples of computer-usable media include static or dynamic random access memory (SRAM or DRAM), read-only memory (ROM), electrically-erasable programmable ROM (EEPROM or flash memory), magnetic media and optical media, whether permanent or removable. Most consumer-oriented computer applications are software solutions provided to the user on some removable computer-usable media, such as a compact disc read-only memory (CD-ROM).

In operation, camera 108 records a geometrical attribute (e.g., size and/or shape) occurring during a relatively short period of time and position of objects, e.g., compliant objects, placed on front side 112 of projection screen 106 and transmits them to video-capture device 114. In describing the various embodiments, although reference is made to specific times, these may refer to intervals of time associated with these specific times. Note that camera 108 can do this for a plurality of compliant objects placed on front side 112 simultaneously. Therefore, touch-screen interface 100 can receive a plurality of inputs substantially simultaneously. Video capture device 114 records the instantaneous size and position on an x-y coordinate map, for example, of front side 112. Moreover, video-capture device 114 records the changes in size of the objects from one time period to another, and thus the rate of change in size, at the various x-y locations. This can be used to determine the rate at which a finger presses against screen 106, for example. Video-capture device 114 also records the change in position of an object on front side 112 from one time period to another and thus the velocity at which the object moves over screen 106.

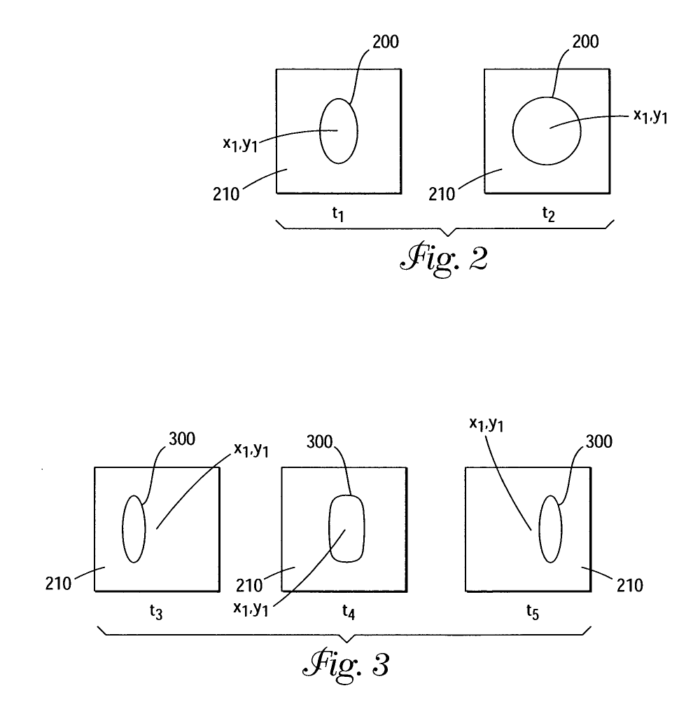

FIG. 2 illustrates a geometrical attribute, such as the shape, of an object 200, such as compliant object, e.g., a finger, a hand palm an entire hand, a foot, a rubber mallet, etc., at two times, time t₁ and time t₂, as observed through rear side 110 of projection screen 106.The objects are contained within a region 210 located, e.g., centered, at x and y locations x₁ and y₁ that give the x-y location of region 210 and thus compliant object 200. When pressure is applied to or released from object 200 its geometrical attributes change, i.e., its size increases or decreases. The size may be determined from a dimensional attributes of object 200, such as its area, diameter, perimeter, etc. For other embodiments, dimensional attributes give a shape of compliant object 200, where the shape is given by ratio of a major to minor axis in the case of an elliptical shape, for example. When pressure is applied to object 200 at time t₁, the shape and/or size of object 200 increases to that at time t₂. The rate of increase the size is then given by the size increase divided by t₂-t₁. Thus, by observing the size of object 200 and its rate of change, the pressure exerted by object 200 on front side 112 and how fast this pressure is exerted can be determined. For some embodiments, this pressure and the rate of change thereof is taken to be applied over the entire region 210 that has a predetermined shape and area about x₁, y₁.

The pressure exerted by compliant object 200, such as a user's fingers, may be determined from a calibration of the user's fingers as follows, for one embodiment. The user places a finger on front side 112 without exerting any force. Camera 108 records the shape and/or size, and the user enters an indicator, such as “soft touch,” into processor 116 indicative of that state. Subsequently, the user presses hard on front side 112; camera 108 records the shape and/or size, and the user enters an indicator, such as “firm touch,” into processor 116 indicative of that state. Intermediate pressures may be entered in the same fashion. For one embodiment, the user selects a calibration mode. The processor prompts the user for an identifier, such as the user's name, prompts the user to place a particular finger onto front side 112 with without any force; camera 108 records the shape; and processor 116 assigns an indicator (e.g., a value or description) to this shape. This may continue for a number of finger pressures for each of the user's fingers. Note that the calibration method could be used for a hand palm an entire hand, a foot, a rubber mallet, etc.

In operation, the user enters his/her identifier, and when the user exerts a pressure, processor 116 uses the calibration to determine the type of pressure. If the pressure lies between two calibration values, processor 116 selects the closer pressure, for some embodiments. For some embodiments, processor 116 relates the pressure to a volume of a sound, such as a musical note, where the higher the pressure, the higher the volume. Moreover, the calibration of different fingers enables processor 116 to recognize different fingers of the user's hand.

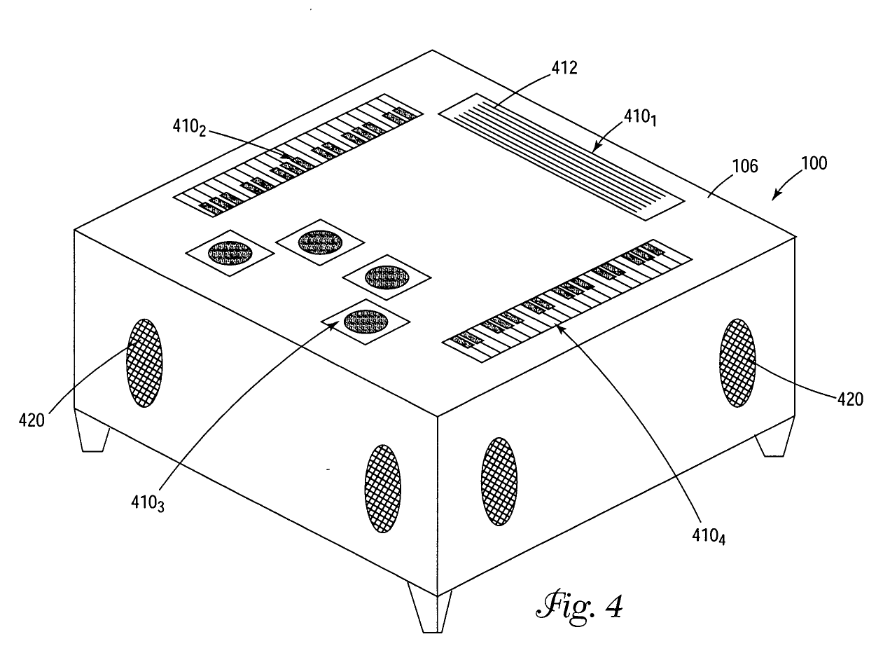

FIG. 3 illustrates images of an object 300 recorded by camera 108 for the region 210 at times t₃, t₄, and t₅, according to another embodiment of the present disclosure. For example, the images may correspond to the user rolling a finger from left to right at a fixed pressure. The times t₃, t₄, and t₅ can be used to determine the rate at which the user is rolling the finger. Note that a change in the size at any of the times t₃, t₄, and t₅ indicates a change in the pressure exerted by the user's finger. For other embodiments, rolling of a hand, hand palm, foot, rubber mallet, can be determined in the same way. For another embodiment, rolling may be determined by a change in shape of object 300 without an appreciable change in size.

FIG. 4 illustrates touch-screen interface 100 in operation, according to another embodiment of the present disclosure. For one embodiment, processor 116 instructs camera 104 (FIG. 1) to project objects 410 onto screen 106. For one embodiment, objects 410 correspond to musical instruments. For example, for another embodiment, object 410, corresponds to a string instrument, e.g., a guitar, violin, bass, etc., objects 4102 and 4104 to different or the same keyboard instruments, e.g., an organ and a piano, two pianos, etc., and objects 4103 to percussion objects. For another embodiment, touch-screen interface 100 may include speakers 420. For one embodiment, each location on each of strings 412 of object 410₁, each key on objects 410₂ and 410₄, and each of objects 410₃ corresponds to an x-y region of screen 106 and thus of a map of the x-y region in video-capture device 114 (FIG. 1), such as region 210 of FIGS. 2 and 3.

Processor 116 (FIG. 1) is programmed, for one embodiment, so that each x-y region of an object 410 corresponds to a different note of that object. That is, when a user places a finger on a key of object 4102, a piano or organ note may sound. When the user varies the pressure on the finger, the volume of that note varies according to the change of shape of the user's finger with pressure. The user may vary the speed at which the note is played by varying the rate at which the pressure is applied to the key. Note that this is accomplished by determining the rate at which the size of the user's finger changes, as described above. For one embodiment processor 116 may be programmed to sustain a sound after the finger is removed.

The user may tap on the strings 412 of object 410₁ to simulate plucking them. Varying the pressure and the rate at which the pressure is applied will vary the volume of the plucking and the rate of plucking, as determined from the changing shape of the plucking finger. For one embodiment, processor 116 may be programmed to change the pitch of object 410₁ when camera 108 and video-capture device 114 detects the user's finger rolling over the strings 412, e.g., as described above in conjunction with FIG. 3. This enables the user to play vibrato, where varying the rate of rolling varies the vibrato. Determining the rate at which the user's fingers move from a first x-y region of an object 410 to a second x-y region of that instrument determines how fast a first musical note corresponding to the first x-y region is changed to a second musical note at the second x-y region. For one embodiment, the rate at which the user's fingers move from a first x-y region of an object 410 to a second x-y region can also be used to change other sound features such as timbre or phase.

For other embodiments, when pressure is applied to an x-y region, processor 116 instructs projector 104 to change an attribute of (or effectively redisplay) that x-y region by re-projecting that x-y region, e.g., such that the x-y region appears depressed on rear side 110 of projection screen 106. Likewise, when the pressure is released from that x-y region, projector changes the x-y region, e.g., such that the x-y region appears as no longer depressed.

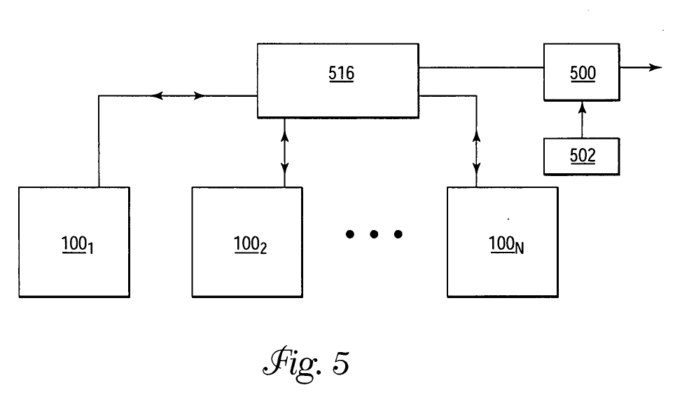

FIG. 5 illustrates a network of touch-screen interfaces 100 used as musical instruments, as was described for FIG. 4, according to another embodiment of the present disclosure. Each touch-screen interface 100 is connected to processor 516. For another embodiment, processor 516 may be integrated within one of the touch-screen interfaces 100. Processor 516, for another embodiment, may be connected to a sound system 500. For yet another embodiment, a Musical Instrument Digital Interface (MIDI) 502 may be connected to sound system 500.

In operation, processor 516 instructs the projector of each touch-screen interface 100 to project objects corresponding to musical instruments onto its projection screen, as was described in conjunction with FIG. 4. Processor 516 receives inputs from each touch-screen interface 100 corresponding to changes in the users'finger shapes and positions on the various musical objects and outputs musical sounds in response to these inputs to sound system 500. For some embodiments, additional musical inputs may be received at sound system 500 from MIDI 502, e.g., from one or more synthesizers. Sound system 500, in turn, outputs the musical sounds.

### CONCLUSION

Although specific embodiments have been illustrated and described herein it is manifestly intended that this disclosure be limited only by the following claims and equivalents thereof.

What is claimed is:

1. A method of operating an interface, comprising:
determining an attribute of an image of an object produced by placing the object on an exterior surface of a touch screen; and
determining a property of an input to the interface based on the attribute of the image.

2. The method of claim 1, wherein determining the property comprises comparing the attribute of the image to an attribute of an image that is pre-calibrated to the property.

3. The method of claim 1, wherein determining an attribute of an image of an object produced by placing the object on an exterior surface of the touch screen comprises photographing the image though an interior surface of the touch screen.

4. The method of claim 1, wherein the object is a user's finger, and the property is pressure exerted by the finger on the touch screen.

5. The method of claim 4, wherein the pressure corresponds to a volume of a musical note.

6. The method of claim 1 further comprises comparing the attribute of the image to an attribute of an image of the object at an earlier time.

7. The method of claim 1, wherein the object is positioned within a region of at least part of an image of a musical instrument projected onto a rear side of the touch-screen.

8. The method of claim 7 further comprises re-projecting the region onto the rear side of the touch-screen in response to changing a pressure exerted on the object positioned within the region.

9. The method of claim 1, wherein determining the property further comprises determining the property based on a location of the object on the exterior surface.

10. The method of claim 1, wherein the attribute comprises a geometrical attribute.

11. A method of operating a touch-screen interface, comprising:
projecting an image of at least a part of at least one musical instrument onto a rear side of a projection screen of the touch-screen interface;
determining a geometrical attribute of an image of each of one or more objects placed onto a front side of the projection screen respectively within one or more regions of the image of the at least part of at least one musical instrument; and
producing a musical sound based on the geometrical attribute of the image of each of the one or more objects that corresponds to the at least one musical instrument.

12. The method of claim 11 further comprises changing the musical sound by moving at least one of the one or more objects to another region of the image of the at least one musical instrument.

13. The method of claim 11 further comprises changing the musical sound by changing the geometrical attribute of the image of at least one of the one or more objects by changing a pressure applied to that object or rolling that object.

14. The method of claim 13 further comprises re-projecting the region of the image of the at least part of at least one musical instrument containing the at least one of the one or more objects onto the rear side of the projection screen in response to changing the size of the image.

15. The method of claim 11 further comprises receiving musical inputs from one or more external sources.

16. The method of claim 15, wherein the one or more external sources comprise at least one or more other touch-screen interfaces and a Musical Instrument Digital Interface.

17. An interface comprising:
a means for determining an attribute of an image of an object produced by placing the object on an exterior surface of a touch screen; and
a means for determining a property of an input to the interface based on the attribute of the image.

18. The interface of claim 17 further comprises a means for creating an image of at least a part of at least one musical instrument on the touch screen.

19. The interface of claim 17 further comprises a means for producing a musical sound based on the attribute of the image.

20. The interface of claim 17 further comprises a means for determining a rate of change of the attribute of the image.

21. The interface of claim 17 further comprises a means for changing an attribute of a region of the touch-screen in response to changing a pressure exerted on the object positioned within the region.

22. An interface comprising:
a rear projection screen;
a projector directed at a rear surface of the rear projection screen;
a camera directed at the rear surface of the rear projection screen for detecting attributes of images of objects positioned on a front surface of the rear projection screen; and
an image-capturer connected to the camera for receiving the attributes of the images of the objects from the camera.

23. The interface of claim 22, wherein the attributes comprise a geometrical attributes.

24. The interface of claim 22 further comprises a processor connected to the image-capturer and the projector.

25. The interface of claim 24, wherein the processor is adapted to instruct the projector to project images of at least a portion of one or more musical instruments onto the rear projection screen.

26. The interface of claim 24, wherein the processor is adapted to assign musical sounds in response to the shapes of the objects during time periods.

27. The interface of claim 22 further comprises a sound system.

28. A computer-usable media containing computer-readable instructions for causing an interface to perform a method, comprising:
determining an attribute of an image of an object produced by placing the object on an exterior surface of a touch screen; and
determining a property of an input to the interface based on the attribute of the image.

29. The method of claim 28, wherein the attribute comprises a geometrical attribute.

30. The computer-usable media of claim 28, wherein, in the method, the object is a user's finger, and the property is pressure exerted by the finger on the touch screen.

31. The computer-usable media of claim 28, wherein the method further comprises comparing the attribute of the image to an attribute of an image of the object at an earlier time.

32. The computer-usable media of claim 28, wherein the method further comprises re-projecting a region onto a rear side of the touch screen in response to changing a pressure exerted on the object.

33. The computer-usable media of claim 28, wherein, in the method, determining the property further comprises determining the property based on a location of the object on the exterior surface.

34. A computer-usable media containing computer-readable instructions for causing a touch-screen interface to perform a method, comprising:
projecting an image of at least a part of at least one musical instrument onto a rear side of a projection screen of the touch-screen interface;
determining a geometrical attribute of an image of each of one or more objects placed onto a front side of the projection screen respectively within one or more regions of the image of the at least a part of at least one musical instrument; and
producing a musical sound based on the geometrical attribute of the image of each of the one or more objects that corresponds to the at least one musical instrument.

35. The computer-usable media of claim 34, wherein the method further comprises changing the musical sound by moving at least one of the one or more objects to another region of the image of the at least one musical instrument.

36. The computer-usable media of claim 34, wherein the method further comprises changing the musical sound by changing the geometrical attribute of the image of at least one of the one or more objects by changing a pressure applied to that object or rolling that object.
